(19) United States
(12) Patent Application Publication
(10) Pub. No.: US 2002/0076613 A1
(43) Pub. Date: Jun. 20, 2002

(54) Method for surface treatment of layered structure oxide for positive electrode in lithium secondary battery

(76) Inventors: Jai Young Lee, Daejeon Kwangyeok-si (KR); Sung Chul Park, Daejeon Kwangyeok-si (KR); Ki Tae Kim, Daejeon Kwangyeok-si (KR); Yong Mook Kang, Daejeon Kwangyeok-si (KR); You Min Kim, Daejeon Kwangyeok-si (KR); Hyun Seok Kim, Daejeon Kwangyeok-si (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 09/828,216

(22) Filed: Apr. 9, 2001

(30) Foreign Application Priority Data
Dec. 15, 2000 (KR) 2000-76942

(51) Int. Cl. H01M 4/48; B05D 5/12

(52) U.S. Cl. 429/231.1; 427/126.3; 427/126.4; 427/126.6

(57) ABSTRACT

The present invention relates to a method for a surface treatment of a layered structure oxide for a positive electrode in a lithium secondary battery. The method includes coating the surface of the layered structure oxide with a lithium transition metal oxide. The lithium secondary battery where the layered structure oxide is used as an active material of the positive electrode solves the problem of the thermal stability suffered conventionally.

### BACKGROUND OF THE INVENTION

1. Field of the Invention

The present invention relates to a method for a surface treatment of a layered structure oxide for a positive electrode in a lithium secondary battery and more particularly, to a method for a surface treatment of a layered structure oxide, for the purpose of improving a thermal stability thereof.

2. Description of the Related Art

As portable electric equipments such as notebooks, camcorders, small-sized recorders or the like are rapidly developed, the demand for the portable electric equipments is increasing. Also, batteries as an energy source for the portable electric equipments are becoming increasingly important and particularly, the demand for a reusable secondary battery is drastically increased. In this case, many studies on the lithium secondary battery exhibiting high energy density and discharge voltage characteristics are made and at present, the lithium secondary battery is commercialized.

Most important parts in the lithium secondary battery are materials constituting negative and positive electrodes. Specifically, the material used for the positive electrode in the lithium secondary battery should meet the following requirements: (1) an inexpensive active material; (2) a high discharge capacity; (3) a high working voltage for obtaining high energy density; (4) an excellent electrode life for the use for a long time; and (5) an enhanced high-speed discharge efficiency for improving energy density per volume and peak power per mass.

The material most early commercialized as the positive electrode in the lithium secondary battery is a lithium cobalt oxide-based material. The lithium cobalt oxide-based material exhibits an excellent electrode life and a high high-speed discharge efficiency, but when heated by a misuse (for example, short-circuit, high temperature keeping, battery destruction or the like) at the state where the battery has been overcharged, it may be exploded by the generation of oxygen with an exothermic reaction due to the reaction of a lithium cobalt oxide and an electrolyte. In order to remove the possibility of the explosion of the battery, therefore, the battery has an expensive PTC device and a vent on a cap thereof, for preventing the overcharging. In addition, in order to make the charge voltage of the battery lowered, the battery uses a smaller capacity than a really available capacity. In particular, in case where the lithium secondary battery is used as a large-sized battery, for example, for an electric vehicle, the stability for the battery is becoming most important in the battery development.

Various studies for improving the stability of the battery, that is, a thermal stability of a layered structure oxide have been made. For example, nickel in a lithium nickel oxide is substituted by aluminum, such that the thermal stability thereof can be improved (See T. Ohzuku, et al., J. of Electrochem. Soc., 142(1995)4033), the nickel therein is substituted by cobalt, manganese and titanium, such that the thermal stability thereof can be improved (See Il Arai, et al., J. of Electrochem. Soc., 144(1997)3177), and the nickel therein is substituted by titanium and magnesium, such that the thermal stability thereof can be improved (See Y. Gao, et al., Electrochem. and Solid-State, lett., 1(1998)117). However, the above substitution methods have a drawback that the capacity is decreased.

On the other hand, a magnesium oxide is coated on the surface of the lithium nickel cobalt oxide, thereby reducing the decrement of the capacity but decreasing the thermal stability (See H. J. Kweon et al., Electrochem. and Solid-State lett., 3(2000)428). However, the surface coating method causes the capacity of the positive electrode material to be decreased, since the magnesium oxide, as a non-active material, that can't carry out charging and discharging is coated on the surface of the oxide.

### SUMMARY OF THE INVENTION

Accordingly, it is an object of the present invention to provide a method for a surface treatment of a layered structure oxide for a positive electrode in a lithium secondary battery, thereby minimizing the decrement of a discharge capacity and at the same time improving a thermal stability.

The present inventors have made various studies to solve the above problems and as a result, they have found that if the surface of the layered structure oxide such as a lithium cobalt oxide, a lithium nickel-based oxide or the like that is famous as a positive electrode material in a lithium secondary battery is coated with a lithium transition metal oxide such as a lithium manganese oxide that can carry out charging and discharging and exhibits an excellent thermal stability, the decrement of discharge capacity is minimized and at the same time the thermal stability is improved.

To accomplish this and other objects of the present invention, there is provided a method for a surface treatment of a layered structure oxide for a positive electrode in a lithium secondary battery comprising the step of coating the surface of the layered structure oxide with a lithium transition metal oxide.

### BRIEF DESCRIPTION OF THE DRAWINGS

FIG. 1 is a graph obtained by analyzing the surface of a lithium manganese oxide-coated lithium cobalt oxide powder by using an energy dispersive spectroscope (EDS);

FIG. 2 is a graph obtained by analyzing the surface of a lithium manganese oxide-coated lithium nickel cobalt oxide powder by using the EDS;

FIG. 3 is a graph illustrating the variation of a discharge capacity at a normal temperature of a lithium manganese oxide-coated lithium cobalt oxide;

FIG. 4 is a graph illustrating the variation of a discharge capacity at a normal temperature of a lithium cobalt aluminum oxide-coated lithium cobalt oxide;

FIG. 5 is a graph obtained by analyzing a thermal stability of a lithium manganese oxide5 coated lithium cobalt oxide into which an electrolyte is contained, by using a differential scanning calorimeter (DSC); and

FIG. 6 is a graph obtained by analyzing a thermal stability of a lithium cobalt aluminum oxide-coated lithium cobalt oxide into which an electrolyte is contained, by using the DSC.

### DETAILED DESCRIPTION OF THE PREFERRED EMBODIMENTS

According to the present invention, a lithium secondary battery uses a layered structure oxide produced according to the method of the present invention as an active material for a positive electrode.

According to the present invention, the surface of the layered structure oxide is coated with a lithium transition metal oxide using a liquid reaction method and the coating method includes the following steps of:

(1) weighing a predetermined amount of lithium transition metal oxide material to be coated, dissolving the resulting material in a solvent and then mixing the resulting solution;

(2) adjusting pH of the resulting solution;

(3) heating the solution to adjust the concentration;

(4) pouring the layered structure oxide into the solution and mixing the resulting solution;

(5) filtering the layered structure oxide coated with the lithium transition metal oxide on the surface thereof from the mixed solution; and

(6) subjecting the resulting layered structure oxide to a dry treatment and then to a heat treatment.

The above steps (1) through (6) will be in detail described hereinafter.

A material for the surface treatment of the layered structure oxide is selected from acetate base, hydroxide base, nitrate base, sulphate base or chlorite base of a metal of lithium and manganese or from acetate base, hydroxide base, nitrate base, sulphate base or chlorite base of a metal such as cobalt (Co), aluminum (Al), iron (Fe), vanadium (V), chromium (Cr), copper (Cu), titanium (Ti), tungsten (W), tantalum (Ta), magnesium (Mg) or molybdenum (Mo).

The weighed material is dissolved in distilled water, alcohol or acetone at a temperature in a range of 80 ° C. to 90 ° C., in a mixed solution where the distilled water and alcohol are mixed in the ratio of 1:1 to 9:1, in a mixed solution where the distilled water and acetone are mixed in the ratio of 1:1 to 9:1, or in a mixed solution where the alcohol and acetone are mixed in the ratio of 1:1 to 9:1, by using a stirrer. Thereafter, a glycolic acid, an adipic acid, a citric acid or a propionic acid is added by 1-3 times as much as the total metal ions. After addition of the acid, liquid ammonia is added to the solution, in manner to have pH in a range of 5 to 9. Next, the resulting solution is refluxed at a temperature in a range of 80 ° C. to 90 ° C. for 6 to 12 hours.

And, the distilled water is evaporated so that the concentration of the solution can be in a range of 0.1 M to 2 M. Then, the layered structure oxide for the positive electrode in the lithium secondary batter is added to the solution. The added layered structure oxide is uniformly coated by using a stirrer, and the coated layered structure oxide is filtered by using a centrifugal separator or filtering paper. In case of using the centrifugal separator, the solution rotates at a rotation speed of 1000 to 2000 rpm for 10 to 60 minutes, thereby filtering the layered structure oxide. The coated layered structure oxide is subjected to a vacuum dry treatment at a temperature in a range of 100 ° C. to 130 ° C. for 2 to 12 hours and then to a heat treatment in an oxygen atmosphere or in the air. It is desirable that the heat treatment is carried out at a temperature in a range of 500 ° C. to 850 ° C. for 3 to 48 hours. If the temperature or time of the heat treatment is under the above condition range, it is difficult to obtain enough crystallization and contrarily, if over the above condition range, the oxide itself may be dissolved.

After the heat treatment, for the purpose of producing the positive electrode of the lithium secondary battery, the coated layered structure oxidized composition is pulverized, and the layered structure oxidized composition coated with the active material and a conductive material are mixed in a solution where a binder is melted in an organic solvent. Thereafter, the mixed solution is covered on an aluminum foil, which is then subjected to a dry treatment in a vacuum oven at a temperature of about 140 ° C. for 1 to 4 hours. Then, the result is compressed by using a press.

An example of the layered structure oxide is LiCo_{1-X}M_{X}O₂, LiNi_{1-X}M_{X}O₂, or LiNil_{1-X-Y}Co_{X}M_{Y}O₂ (wherein 0≦X<0.5, 0≦Y<0.5 and M=one selected from Mg, Sn, Mn and Sr).

Examples of the lithium transition metal oxide exhibiting an excellent thermal stability that can be used in the present invention are LiMn_{2-X}M1_{X}O₄, LiCo_{1-X}Al_{X}O₂, LiNi_{1-X}Al_{X}O₂, LiNi_{1-X-Y}Co_{X}Al_{Y}O₂, and LiNi_{1-X-Y-Z}Co_{X}M1_{Y}M2_{Z}O₂ (wherein M1 and M2=one selected from Al, Ni, Co, Fe, Mn, V, Cr, Cu, Ti, W, Ta, Mg and Mo, and X, Y and Z represent the atomic percentages of the respective oxide composition elements and meet the conditions that 0≦X<0.5, 0≦Y<0.5 and 0≦Z<0.5).

The present invention will now be described in detail by way of particular embodiments.

Embodiment 1

Lithium and manganese and the respective acetate as starting materials were weighed in a mol ratio of 1:2 in a reaction kettle and then dissolved into distilled water having a temperature of 85 ° C. using a stirrer. Then, a glycolic acid was added by 1.7 times as much as the total metal ions. After addition of the acid, liquid ammonia was added to the solution, in manner to have pH of 7. Next, the resulting solution was refluxed at a temperature of 85 ° C. for 6 hours. Then, the distilled water was evaporated and the concentration of the solution was adjusted. And, a lithium cobalt oxide (LiCoO₂) was added to the solution. The added lithium cobalt oxide was uniformly mixed and coated by using a stirrer, and the resulting solution was removed by using a centrifugal separator at a rotation speed of 1500 rpm for 30 minutes, thereby producing the coated lithium cobalt oxide (LiMn₂O₄-coated LiCoO₂). The produced coated lithium cobalt oxide was subjected to a vacuum dry treatment at a temperature of 120 ° C. for 2 hours and then to a heat treatment in an oxygen atmosphere at a temperature of 800 ° C. for 6 hours.

According to the result of a scanning electron microscope (SEM) structure of a lithium manganese oxide-coated lithium cobalt oxide powder, it was confirmed that small lithium manganese oxide particles were coated on the surface of the lithium cobalt oxide powder.

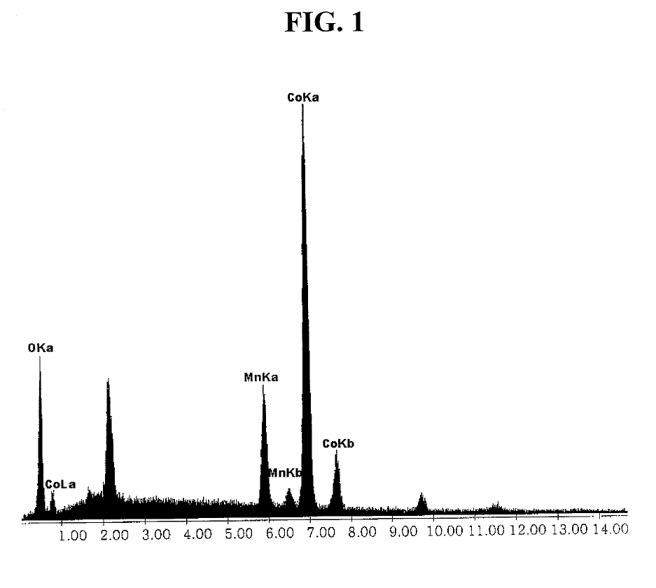

FIG. 1 is a graph obtained by analyzing the surface of a lithium manganese oxide-coated lithium cobalt oxide powder by using an EDS. Based upon the fact that manganese and cobalt appeared, it could be found that the lithium manganese oxide was coated on the surface of the lithium cobalt oxide.

On the other hand, for the purpose of producing the positive electrode of the lithium secondary battery, a polyvinylidene binder was dissolved in an N-methylpyrrolidinone solvent and the resulting solution was mixed with the active material of the above-produced lithium manganese oxide-coated lithium cobalt oxide and a known conductive material used generally in a secondary battery. Thereafter, the mixed solution was covered on an aluminum foil, which was subjected to a dry treatment in a vacuum oven at a temperature of 140 ° C. Then, the resulting product was compressed by using a press.

A half battery for test of a coin shape made of stainless steel was manufactured by using the produced positive electrode for the lithium secondary battery and the lithium metal foil, and with the manufactured battery, the charging and discharging test was carried out. At this time, the negative electrode used a lithium metal and the electrolyte used LiPF₆/EC:DEC (1:1).

Embodiment 2

The production of the half battery was made in the same manner as in Embodiment 1, except that a lithium nickel cobalt oxide was employed as the layered structure oxide.

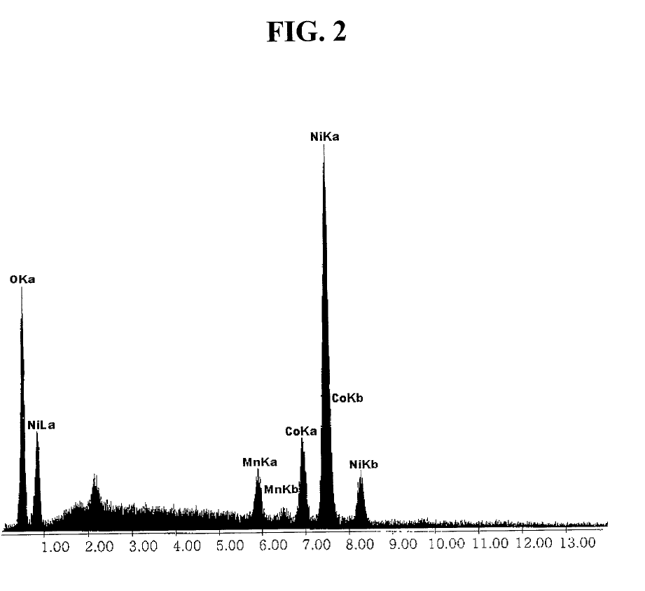

FIG. 2 is a graph obtained by analyzing the surface of a lithium manganese oxide-coated lithium nickel oxide powder by using the EDS. Based upon the fact that manganese, nickel and cobalt appeared, it could be found that the lithium manganese oxide was coated on the surface of the lithium nickel cobalt oxide.

Embodiment 3

The production of the half battery was made in the same manner as in Embodiment 1, except that lithium, cobalt and aluminum and the respective acetate as starting materials were weighed in a mol ratio of 1:0.95:0.05.

Embodiment 4

The production of the half battery was made in the same manner as in Embodiment 1, except that lithium, nickel and aluminum and the respective acetate as starting materials were weighed in a mol ratio of 1:0.9:0.1.

Embodiment 5

The production of the half battery was made in the same manner as in Embodiment 1, except that lithium, nickel, cobalt and aluminum and the respective acetate as starting materials were weighed in a mol ratio of 1:0.8:0.15:0.05.

### EXAMPLE 1

Measurement of Discharge Capacity at a Normal Temperature of a Lithium Manganese Oxide-Coated Lithium Cobalt Oxide

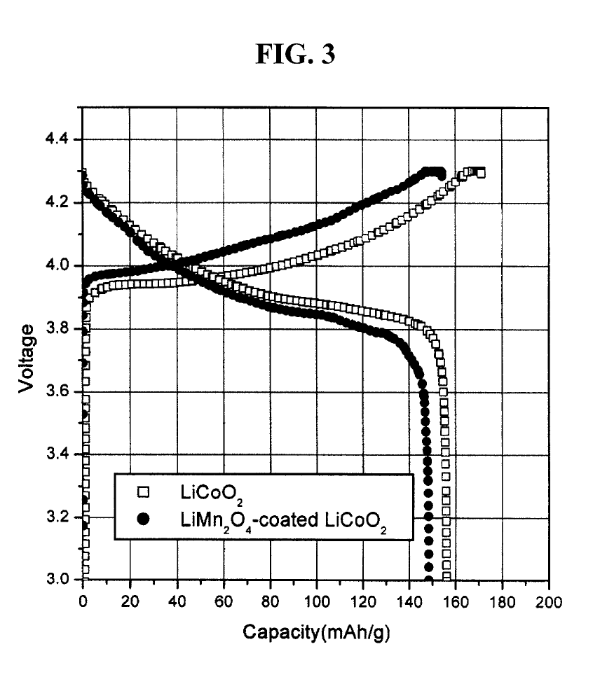

FIG. 3 is a graph illustrating the variations of discharge capacities at a normal temperature of a lithium manganese oxide-coated lithium cobalt oxide (LiMn₂O₄-coated LiCoO₂) and of a pure lithium cobalt oxide not coated with the lithium manganese oxide. As apparent from FIG. 3, it could be found that the lithium manganese oxide-coated lithium cobalt oxide exhibited a great small amount of capacity decrement.

### EXAMPLE 2

Measurement of Discharge Capacity at a Normal Temperature of a Lithium Cobalt Aluminum Oxide-Coated Lithium Cobalt Oxide

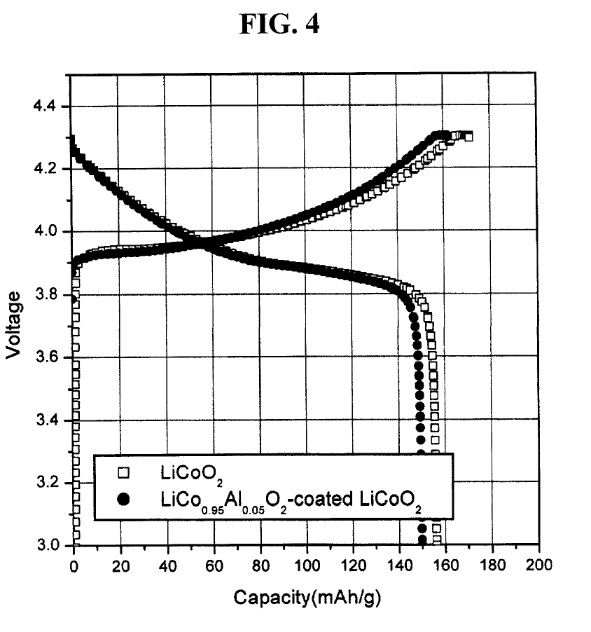

FIG. 4 is a graph illustrating the variations of discharge capacities at a normal temperature of a lithium cobalt aluminum oxide-coated lithium cobalt oxide (LiCo_{0.95}Al_{0.05}O₄-coated LiCoO₂) and of a pure lithium cobalt oxide not coated with the lithium cobalt aluminum oxide. As apparent from FIG. 4, it could be found that the lithium cobalt aluminum oxide-coated lithium cobalt oxide exhibited a great small amount of capacity decrement.

### EXAMPLE 3

Measurement of Thermal Stability of a Lithium Manganese Oxide-Coated Lithium Cobalt Oxide

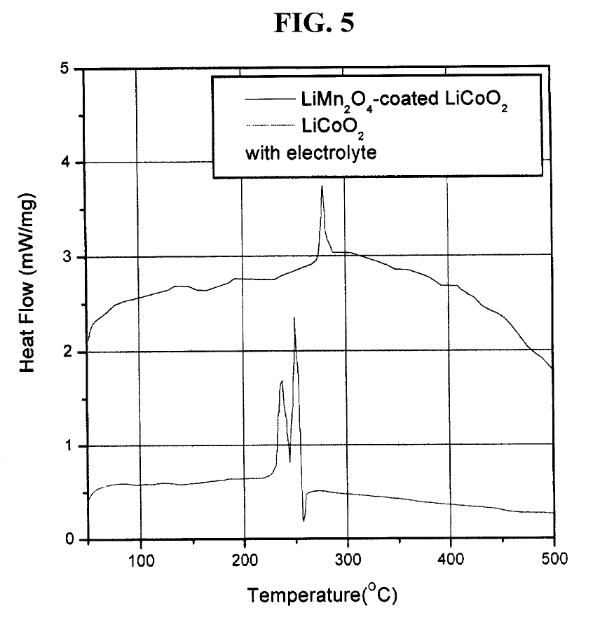

FIG. 5 is a graph showing heat flows and temperatures obtained by the reactions of a lithium manganese oxide-coated lithium cobalt oxide (LiMn₂O₄-coated LiCoO₂) and a pure lithium cobalt oxide not coated with the lithium manganese oxide with an electrolyte. As apparent from FIG. 5, it could be found that the lithium manganese oxide-coated lithium cobalt oxide exhibited a high heat flows decrement and a high temperature increment, when compared with the lithium cobalt oxide not coated with the lithium manganese oxide, resulting in the improvement of the thermal stability.

### EXAMPLE 4

Measurement of Thermal Stability of a Lithium Cobalt Aluminum Oxide-Coated Lithium Cobalt Oxide

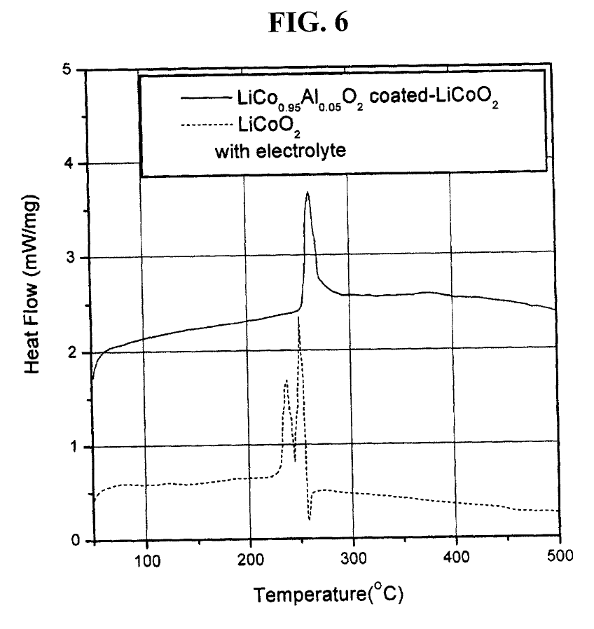

FIG. 6 is a graph showing heat flows and temperatures obtained by the reactions of a lithium cobalt aluminum oxide-coated lithium cobalt oxide (LiCo_{0.95}Al_{0.05}O₄-coated LiCoO₂) and of a pure lithium cobalt oxide not coated with the lithium cobalt aluminum oxide with an electrolyte. As apparent from FIG. 6, it could be found that the lithium cobalt aluminum oxide-coated lithium cobalt oxide exhibited a high heat flows decrement and a high temperature increment, when compared with the lithium cobalt oxide not coated with the lithium cobalt aluminum oxide, resulting in the improvement of the thermal stability.

As clearly set forth in the above discussion, a method for a surface treatment of a layered structure oxide for a positive electrode in a lithium secondary battery according to the present invention is directed to a positive electrode material for a high performance lithium secondary battery that exhibits an improved thermal stability. Particularly, the replacement of an existing commercialized layered structure oxide enables the stability of the lithium secondary battery to be achieved. In addition, the employment for expensive safety devices such as a PTC device, a vent or the like that are essentially used in the existing lithium secondary battery is reduced, such that a low-priced lithium secondary battery can be manufactured.

Therefore, the lithium secondary battery is given much weight in the field of secondary batteries used in portable phones, camcorders, notebook computers or the like, particularly in the field of electric vehicles where the stability of the battery is considered as a most important performance factor.

What is claimed is:

1. A method for a surface treatment of a layered structure oxide for a positive electrode in a lithium secondary battery comprising the step of: coating the surface of the layered structure oxide with a lithium transition metal oxide.

2. The method of claim 1, wherein the method for coating the lithium transition metal oxide comprises the steps of:
weighing a predetermined amount of lithium transition metal oxide material to be coated, dissolving the resulting material in a solvent and then mixing the resulting solution;
adjusting pH of the resulting solution;
heating the solution to adjust the concentration;
pouring the layered structure oxide into the solution and mixing the resulting solution;
filtering the layered structure oxide coated with the lithium transition metal oxide on the surface thereof from the mixed solution; and
subjecting the resulting layered structure oxide to a dry treatment and then to a heat treatment.

3. The method of claim 2, wherein the material is selected from acetate base, hydroxide base, nitrate base, sulphate base or chlorite base of the metal.

4. The method of claim 2, wherein the material is dissolved in distilled water, alcohol or acetone, in a mixed solution where the distilled water and alcohol are mixed in the ratio of 1:1 to 9:1, in a mixed solution where the distilled water and acetone are mixed in the ratio of 1:1 to 9:1, or in a mixed solution where the alcohol and acetone are mixed in the ratio of 1:1 to 9:1.

5. The method of claim 2, wherein the pH of the solution is adjusted in a range of 5 to 9.

6. The method of claim 2, wherein the concentration is adjusted in a range of 0.1 M to 2 M.

7. The method of claim 2, wherein the lithium transition metal oxide is one selected from LiMn_{2-X}M1_{X}O₄, LiCo_{1-X}Al_{X}O₂, LiNi_{1-X}Al_{X}O₂, LiNi_{1-X-Y}Co_{X}Al_{Y}O₂, and LiNi_{1-X-Y-Z}Co_{X}M1_{Y}M2_{Z}O₂ (wherein M1 and M2=one selected from Al, Ni, Co, Fe, Mn, V, Cr, Cu, Ti, W, Ta, Mg and Mo, and X, Y and Z represent the atomic percentages of the respective oxide composition elements and meet the conditions that 0≦X<0.5, 0≦Y<0.5 and 0≦Z<0.5).

8. The method of claim 2, wherein the coated layered structure oxide is filtered by using filtering paper or centrifugally separated at a rotation speed of 1000 to 2000 rpm for 10 to 60 minutes, thereby filtering the coated layered structure oxide.

9. The method of claim 2, wherein the heat treatment after drying in a vacuum state is carried out in an oxygen atmosphere or in the air.

10. The method of claim 2, wherein the metal is selected from Li, Ni, Co, Al, Fe, Mn, V, Cr, Cu, Ti, W, Ta, Mg and Mo.

11. The method of claim 2, wherein the layered structure oxide is LiCo_{1-X}M_{X}O₂, LiNi_{1-X}M_{X}O₂, Or LiNi_{1-X-Y}Co_{X}M_{Y}O₂ (wherein 0≦X<0. 5, 0≦Y<0. 5 and M=one selected from Mg, Sn, Mn and Sr).

12. A lithium secondary battery using a layered structure oxide coated with a lithium transition metal oxide, as a positive electrode of the battery, manufactured according to a method for coating the lithium transition metal oxide comprises the steps of:
weighing a predetermined amount of lithium transition metal oxide material to be coated, dissolving the resulting material in a solvent and then mixing the resulting solution;
adjusting pH of the resulting solution;
heating the solution to adjust the concentration;
pouring the layered structure oxide into the solution and mixing the resulting solution;
filtering the layered structure oxide coated with the lithium transition metal oxide on the surface thereof from the mixed solution; and
subjecting the resulting layered structure oxide to a dry treatment and then to a heat treatment.
